(19) United States
(12) Patent Application Publication
(10) Pub. No.: US 2015/0024991 A1
(43) Pub. Date: Jan. 22, 2015

(54) PEROXY SALT COMPOSITIONS AND USES THEREOF

(71) Applicant: OMS Investments, Inc., Los Angeles, CA (US)

(72) Inventor: James F. Essinger, Cincinnati, OH (US)

(21) Appl. No.: 14/358,870

(22) PCT Filed: Nov. 16, 2012
(86) PCT No.: PCT/US12/65604

§ 371 Date: May 16, 2014

Related U.S. Application Data
(60) Provisional application No. 61/560,584, filed on Nov. 16, 2011.

(51) Int. Cl. C11D 7/04; C11D 7/14; C11D 7/12; C11D 7/50

(52) U.S. Cl. CPC C11D 7/04; C11D 7/5022; C11D 7/14; C11D 7/12
USPC 510/378; 510/375

(57) ABSTRACT

A composition comprising a peroxy salt, fumed silica, and a non-aqueous, water miscible material. These compositions exhibit improved storage stability relative to compositions lacking fumed silica. The peroxy salt is preferably sodium percarbonate. The preparation of the peroxy salt compositions, such as sodium percarbonate compositions described herein, includes non-aqueous liquids as well as solids. The compositions surprisingly, and unexpectedly, exhibit acceptable chemical stability at room temperature in sealed containers. The improved stability is thought to be due to the inclusion of fumed silica in the non-aqueous compositions described herein. The tendency of the composition to decompose in the container is notably reduced and even eliminated, compared to compositions lacking fumed silica.

### FIELD OF INVENTION

The present invention relates generally to compositions comprising sodium percarbonate and a material which is liquid during the preparation of the composition, where the compositions have improved storage stability.

### BACKGROUND OF THE INVENTION

Sodium percarbonate is widely used as an oxidizing ingredient in cleaning compositions. Sodium percarbonate compositions containing liquids are known to exhibit unacceptable chemical stability in storage. If such compositions are not properly formulated or stored, the sodium percarbonate decomposes and produces oxygen gas. For example, if such compositions are exposed to excess moisture, oxygen generation begins, and pressure builds up inside the container in which the composition is stored. The combination of pressure and oxygen gas can be dangerous, as it can lead to the explosion of the container.

Dry sodium percarbonate compositions are well-known. These dry compositions are added to water to achieve the ready-to-use diluted composition. But, such dry compositions, though relatively stable, are not readily dispersed in water, and dispersion is slow even with stirring.

### SUMMARY OF THE INVENTION

There is therefore a need for compositions comprising peroxy salts, such as sodium percarbonate that not only exhibit improved storage stability, but can also be readily dispersed in water.

The preparation of the peroxy salt compositions, such as sodium percarbonate compositions described herein, includes non-aqueous liquids as well as solids. The compositions surprisingly, and unexpectedly, exhibit acceptable chemical stability at room temperature in sealed containers. The improved stability is thought to be due to the inclusion of fumed silica in the non-aqueous compositions described herein. The tendency of the composition to decompose in the container is notably reduced and even eliminated, compared to compositions lacking fumed silica.

In one embodiment, therefore, the invention relates to a composition comprising a peroxy salt, fumed silica, and a non-aqueous, water miscible material.

In another embodiment, the invention relates to a non-aqueous, flowable liquid composition comprising a peroxy salt and fumed silica.

In yet another embodiment, the invention relates to a non-aqueous dispersion comprising a peroxy salt and fumed silica in a water miscible material. The dispersions can be solid-in-liquid dispersions or solid-in-solid dispersions.

In another embodiment, the invention relates to a tablet comprising a peroxy salt, fumed silica, and a non-aqueous water miscible material. In an alternative embodiment, the invention relates to a tablet comprising a peroxy salt, fumed silica, and a polymeric alcohol that is solid at 25° C. In an alternative embodiment, the invention relates to a tablet comprising a peroxy salt, fumed silica, and a polymeric glycol that is solid at 25° C.

In still another embodiment, the invention relates to a method for cleaning surfaces comprising: (a) diluting a composition comprising a a peroxy salt, fumed silica, and a non-aqueous, water miscible material with water to make a solution or dispersion; and (b) spraying said solution or dispersion onto said surfaces.

In another embodiment, the invention relates to a method for cleaning surfaces comprising spraying a water-diluted composition comprising a peroxy salt, fumed silica, and a non-aqueous, water miscible material onto said surfaces. In all of the above-described embodiments, sodium carbonate is the preferred peroxy salt.

### BRIEF DESCRIPTION OF THE DRAWINGS

FIG. 1 depicts a hose-end device that may be used to apply some compositions described herein.

### DETAILED DESCRIPTION OF PREFERRED EMBODIMENTS

The invention relates generally to compositions comprising a peroxy salt, preferably sodium percarbonate and a non-aqueous water miscible material which is liquid or solid during the preparation of the composition. The compositions comprise a peroxy salt, preferably sodium percarbonate, fumed silica, and a non-aqueous, water miscible material. As used herein, the term “water miscible” means the water miscible material, when added to water, substantially does not produce two separate phases. In some embodiments, compositions according to the invention are flowable at room temperature. In other embodiments, compositions according to the invention are not flowable at room temperature.

In some embodiments, the non-aqueous, water miscible material comprises a hydroxylic solvent. Broadly, the term “hydroxylic solvent” encompasses mono hydroxy alcohols, glycols (i.e., diols or dihydroxy alcohols), and polymeric alcohols (e.g., polyvinyl alcohol), including, for example, polymeric glycols. The term “polymeric glycol” encompasses a polymer comprising glycol monomers. In a preferred embodiment, the mono hydroxy alcohols, glycols, and polymeric glycols do not exhibit any appreciable toxicity to mammals, especially humans.

Exemplary mono hydroxy alcohols include, but are not limited to, methanol, ethanol, n-propanol, i-propanol, and the like. Exemplary glycols include, but are not limited to ethylene glycol, diethylene glycol , propylene glycol, dipropylene glycol, glycerol, 1,2-butylene glycol, 1,3-butylene glycol, 2,3-butylene glycol, and the like. Exemplary polymeric glycols include, but are not limited to polypropylene glycol, polyethylene glycol, poly glycerol and the like. In some embodiments, the polymeric glycols are oligomers comprising between three and ten repeating monomer units. In other embodiments, the polymeric glycols are polymers comprising three or more repeating monomer units, so long as the water miscibility of the polymeric glycol is substantially maintained. In other embodiments, the polymeric glycols are polymers comprising one hundred or more repeating monomer units, so long as the water miscibility of the polymeric glycol is substantially maintained. Thus, for example, when the polymeric glycol is polyethylene glycol having the formula:

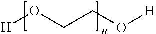

in one embodiment, n is between 3 and 100; 10 to 100; or 100 or more.

In some embodiments; the polymeric glycols have a molecular weight of 2500 g/mol or less, e.g., 1800-2200 g/mol. In other embodiments, the polymeric glycol is a solid at 25° C. (e.g., PEG 2000, which has a pour point of 50° C.).

In some embodiments, one or more of the hydroxyl groups on the polymeric glycols comprise an alkyl cap. The term “alkyl cap,” as used herein, means that an ether is formed at the one or more hydroxyl groups on the polymeric glycols. The ether is an alkyl ether, where the alkyl group can be a methyl, ethyl, or propyl group, so long as the water miscibility of the alkyl capped polymeric glycol is substantially maintained. An exemplary, non-limiting, alkyl capped polymeric glycol is dipropylene glycol methyl ether (DOWANOL™ DPM, The Dow Chemical Company, Wilmington, Del.).

In some embodiments, the compositions of the present invention will further comprise a surface residual treatment agent. When the compositions of the present invention are used to clean surfaces (e.g., wood, concrete, plastic siding, metal siding, glass, ceramic, etc.), the surface residual treatment agent will remain on the surface or inside the interstices of the surface, after the surface is cleaned. Thus, for example, when the compositions of the present invention are used to clean wood and the compositions comprise a surface residual treatment agent, the agent will remain on or in the wood.

The surface residual treatment agent can be, for example, a material having pesticidial activity, for example a material having fungicidal activity, or a material that imparts a water proofing quality. The surface residual treatment agent can be chosen to impart any desirable quality onto the surface that is cleaned.

In some embodiments, the surface residual treatment agent comprises a fatty acid ester. In other embodiments, the surface residual treatment agent comprises a glycerol mono fatty acid ester, e.g., a glycerol mono C₈-C12 fatty acid. An exemplary, but non-limiting, glycerol mono fatty acid ester is glycerol monolaureate.

In other embodiments, the surface residual treatment agent comprises a siloxane, which, in some embodiments can bind to the surface that is cleaned. Thus, for example, when the surface that is cleaned is a glass surface, the siloxane in the compositions described herein will react with silanol groups on the glass. In some embodiments, the siloxane comprises a cyclic polysiloxane. An exemplary, but non-limiting, cyclic polysiloxane is decamethylcyclopentasiloxane.

In some embodiments, the compositions of the embodiments of the present invention will further comprise a surfactant (anionic, non-ionic, cationic, and amphoteric surfactants, and mixtures thereof). In some embodiments, the surfactant comprises a water soluble organic anionic surfactant, amine oxide, phosphine oxide, sulfoxide, sulfonate (e.g., DOWFAX® linear or branched alkali metal mono-and/or di-(C₈-C₁₄) alkyl diphenyl oxide mono and/or disulfonates available from Dow Chemical Company), sulfate, betaine, primary alkyl sulfate, alkyl sulfate, arylalkylsulfonate and/or a secondary alkylsulfonate. Exemplary anionic surfactants include sodium (C₁₀-C₁₈) alkylsulfonates such as sodium dodecylsulfate, sodium alkylsulfates such as sodium hexadecyl-1-sulfonate, and sodium (C₁₂-C₁₈) alkylbenzenesulfonates such as sodium dodecylbenzenesulfonate. The corresponding potassium salts of the foregoing are also acceptable.

Exemplary non-ionic surfactants are high and low foam surfactants such as poly-lower alkoxylated higher alcohols in which the alcohol contains 9 to 18 carbon atoms and the number of moles of lower alkylene oxide (2 or 3 carbon atoms) is from 3 to 12. Exemplary nonionic surfactants useful with the present invention include the low foam PLURAFAC® series from BASF Chemical Company. These surfactants are the reaction product of a higher linear alcohol and a mixture of propylene oxide and ethylene oxides, containing a mixed chain of propylene oxide and ethylene oxide terminated by a hydroxyl group. Specific examples include a C₁₃-C₁₅ fatty alcohol condensed with 6 moles of ethylene oxide and 3 moles of propylene oxide and a C₁₃-C₁₅ fatty alcohol condensed with 7 moles of propylene oxide and 4 moles of ethylene oxide. Exemplary surfactants in the PLURAFAC family of surfactants include Plurafac® LF 132, Plurafac® LF 231, Plurafac® LF 303, Plurafac® LF 305, Plurafac® S 305LF, Plurafac® RA 40, Plurafac® RA 30, Plurafac® 25R2, Plurafac® SLF 18, and Plurafac® SLF 18B-45.

Other exemplary non-ionic surfactants include condensation products of a mixture of higher fatty alcohols averaging about 12 to 15 carbon atoms with about 6.5 to 7 moles of ethylene oxide under the name NEODOL® by Shell Chemical Company such as Neodol® 25-7 and Neodol® 25-6.5. Still further exemplary nonionic surfactants include linear secondary alcohol ethoxylates, and linear alcohols having randomly distributed ethoxy and propoxy groups sold under name TERGITOL® by Union Carbide such as Tergitol® 15-S-7, Tergitol® 15-S-9, and Tergitol® MDS-42. The POLY-TERGENT® family of low foaming, biodegradable alkoxylated linear fatty alcohols by Olin Corporation are also exemplary surfactants suitable for use with the present invention. Particularly preferred Poly-Tergent® surfactants include Poly-Tergent® S-LF 18, Ploy-Tergent® S-303-LF, Poly-Tergent® S-305-LF, Poly-Tergent® S-405-LF and CS-1.

Additional exemplary surfactants include alkylpolysaccharide surfactants having a hydrophobic group containing about 8 to 20 carbon atoms. Preferably, these surfactants comprise about 10 to 16 carbon atoms (most preferably 12 to 14 carbon atoms) and about 1.5 to 10 saccharide units (e.g., fructosyl, glucosyl and galactosyl units). Exemplary surfactants suitable for use with the present invention include alkylpolysaccharide surfactants particularly those available from Henkel Corporation under name APG characterized by the general formula CₙH₂ₙ₊₁—O—(C₆H₁₀O₅)_{x-H9} wherein C₆H₁₀O₅ represents a glucose unit, such as APG 625. An exemplary, but non-limiting, surfactant is sodium dodecyl sulfate.

In other embodiments, the compositions of the present invention will further comprise a wetting agent. In some embodiments, the wetting agent comprises a C₁₂-C₁₆ ethoxylated alcohol. An exemplary, but non-limiting, wetting agent is sodium dodecylsulfate.

In some embodiments, the compositions of the present invention further comprise a “pH booster” that helps adjust the pH of the compositions above 7. Exemplary, but non-limiting, pH boosters are sodium carbonate and trisodium phosphate.

In some embodiments, the compositions of the present invention comprise:
sodium percarbonate, fumed silica, a non-aqueous, water miscible material, and a wetting/foaming agent;
sodium percarbonate, fumed silica, a non-aqueous, water miscible material, a wetting/foaming agent, and a pH booster;
sodium percarbonate, fumed silica, a non-aqueous, water miscible material, and a pH booster; or
sodium percarbonate, fumed silica, a non-aqueous, water miscible material, and a surface residual treatment.

The compositions of the embodiments of the present invention are non-aqueous and preferably, though not necessarily, flowable. In some embodiments, the compositions are non-aqueous dispersions of sodium percarbonate and fumed silica in a water miscible material. The dispersions can be solid-in-liquid dispersions, but they can also be solid-in-solid dispersions. An exemplary, but non-limiting, solid-in-solid dispersion is a tablet where the sodium percarbonate and fumed silica are dispersed in a polymeric glycol that is solid at 25° C.

Other compositions of the embodiments of the present invention comprise a peroxy salt, fumed silica, and a non-aqueous, water miscible material. Sodium percarbonate is one exemplary peroxy salt, but other peroxy salts are contemplated. Such peroxy salts, like sodium percarbonate, can produce oxygen upon contact with water. Other peroxy salts will produce peroxide. Other peroxy salts contemplated herein include sodium perborate. In the case of sodium perborate, upon contact with water, the salt will produce peroxide and borate (BO₃)³⁻.

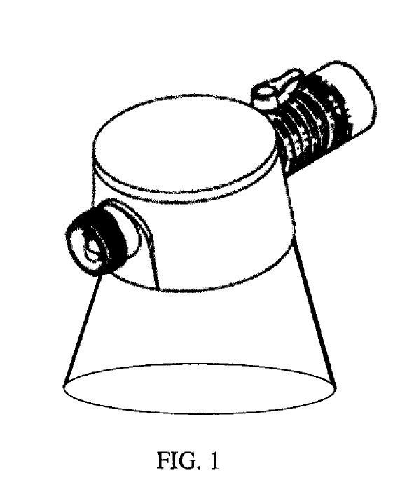

In some embodiments, the compositions described herein are used to clean surfaces. In one embodiment, the method for cleaning the surfaces comprises first diluting a composition comprising sodium percarbonate or sodium perborate, fumed silica and a non-aqueous, water miscible material with water to make a solution or dispersion. The resulting solution or dispersion is subsequently sprayed onto said surfaces to be cleaned. The “diluting” can occur in sequence, simultaneously, or substantially simultaneously with the spraying, for example when a hose-end device (e.g., Miracle-Gro® garden feeder or a pressure-washer) is used to apply the composition to the surface. An example hose-end device is depicted in FIG. 1.

It should be understood that, though only the sodium salts of percarbonate and perborate are described herein, others salts are contemplated herein including, but not limited to, the potassium salts of percarbonate and perborate.

Having now generally described the invention, the same will be more readily understood by reference to the following examples, which are provided by way of illustration and are not intended as limiting. It is understood that various modifications and changes can be made to the herein disclosed exemplary embodiments without departing from the spirit and scope of the invention.

### EXAMPLES

The compositions described in Table 1, below, except for Composition G, are achieved by mixing at room temperature. Care must be taken to protect the compositions from excess humidity/water exposure during processing (e.g., as they are made). Compositions A, B, C, E and F are slow-flowing viscous opaque suspensions that can be poured in containers, filled in pouches (e.g., water-soluble film), or extruded (e.g., caulking gun tubes).

Composition D is a “wet” powder which can be scooped, filled in pouches, and subsequently used.

Composition G can be molded into various shapes by heating the composition to less than 50° C.; injecting or pouring the composition into, e.g., a mold; and letting the composition cool to make rods, tablets, and the like.

TABLE 1

| | Ingredient | | Formula Weight % | | | | | | |
|---|---|---|---|---|---|---|---|---|---|
| Ingredient | Purpose | CAS# | A | B | C | D | E | F | G |
| sodium percarbonate | oxidizer, stain | 15630- | 45 | 15 | 22 | 75 | 45 | 45 | 45 |
| | removal | 89-4 | | | | | | | |
| sodium carbonate | pH booster, | 497-19-8 | 0 | 30 | 39 | 0 | 0 | 0 | 0 |
| | diluent | | | | | | | | |
| alcohol C12-C16, | wetting agent | 68002- | 0 | 0 | 2 | 0 | 0 | 0 | 0 |
| ethoxylated | | 97-1 | | | | | | | |
| decamethylcyclopenta- | surface | 541-02-6 | 0 | 0 | 0 | 0 | 0 | 10 | 0 |
| siloxane | residual | | | | | | | | |
| | treatment | | | | | | | | |
| sodium dodecyl | wetting agent, | 151-21-3 | 8 | 8 | 0 | 13 | 4 | 8 | 8 |
| sulfate | foaming agent | | | | | | | | |
| glycerol monolaurate | surface | 142-18-7 | 0 | 0 | 0 | 0 | 4 | 0 | 0 |
| | residual | | | | | | | | |
| | treatment | | | | | | | | |
| silica, fumed | stabilizer, | 112945- | 2 | 2 | 3 | 2 | 2 | 2 | 2 |
| | viscosity | 52-5 | | | | | | | |
| | modifier | | | | | | | | |
| polyethylene glycol, | diluent, | 25322- | 0 | 0 | 0 | 0 | 0 | 0 | 45 |
| 2000 MW | binding agent | 68-3 | | | | | | | |
| propylene glycol | diluent, | 57-55-6 | 45 | 45 | 34 | 10 | 45 | 35 | 0 |
| | wetting agent | | | | | | | | |
| TOTAL | | | 100 | 100 | 100 | 100 | 100 | 100 | 100 |
| Phsical Form | | | 1 | 1 | 1 | 2 | 1 | 1 | 3 |

1. viscous white liquid, suspension, non-aqueous
2. tacky powder, non-aqueous
3. moldable solid, non-aqueous

The invention described and claimed herein is not to be limited in scope by the specific embodiments herein disclosed, since these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A composition comprising a peroxy salt, fumed silica, and a non-aqueous, water miscible material.

2. The composition of claim 1, wherein the peroxy salt is a percarbonate salt, a perborate salt, a sodium peroxy salt, or mixtures thereof.

3. (canceled)

4. The A composition of claim 1, wherein the peroxy salt is sodium percarbonate.

5. The composition of claim 4, wherein the non-aqueous, water miscible material comprises a hydroxylic solvent.

6. The composition of claim 5, wherein the hydroxylic solvent comprises a mono hydroxy alcohol, a glycol, a polymeric alcohol, or a polymeric glycol.

7. (canceled)

8. The composition of claim 6, wherein the glycol is propylene glycol, ethylene glycol, dipropylene glycol, glycerol, or mixtures thereof.

9-10. (canceled)

11. The composition of claim 6, wherein the polymeric glycol comprises polyethylene glycol, polypropylene glycol or polyglycerol,

12. (canceled)

13. The composition of claim 6, wherein the polymeric glycol is solid at 25° C.

14. (canceled)

15. The composition of claim 4, further comprising a surface residual treatment agent.

16. The composition of claim 15, wherein the surface residual treatment agent comprises a fatty acid ester, a glycerol mono fatty acid ester, or a siloxane.

17. (canceled)

18. The composition of claim 16, wherein the glycerol mono fatty acid ester comprises a C8-C12 fatty acid or glycerol monolaureate.

19-20. (canceled)

21. The composition of claim 16, wherein the siloxane comprises a cyclic polysiloxane.

22. The composition of claim 21, wherein the cyclic polysiloxane is decamethylcyclopentasiloxane.

23. The composition of claim 4, further comprising a surfactant.

24. The composition of claim 23, wherein the surfactant comprises sodium dodecyl sulfate.

25. The composition of claim 4, further comprising a wetting agent.

26. The composition of claim 25, wherein the wetting agent comprises a C₁₂-C₁₆ ethoxylated alcohol.

27. A non-aqueous, flowable liquid composition comprising sodium percarbonate and fumed silica.

28-29. (canceled)

30. A tablet comprising the composition of claim 4.

31-32. (canceled)

33. A method for cleaning surfaces comprising spraying a water-diluted composition comprising a peroxy salt, fumed silica, and a non-aqueous, water miscible material onto said surfaces.

34-37. (canceled)
